(19) United States
(12) Patent Application Publication
(10) Pub. No.: US 2006/0222187 A1
(43) Pub. Date: Oct. 5, 2006

(54) Microphone and sound image processing system

(76) Inventors: Scott Jarrett, Hudson, WI (US); Thomas William Day, Little Canada, MN (US)

Correspondence Address: FISH & RICHARDSON P.C., PO BOX 1022, MINNEAPOLIS, MN, 55440-1022, US

(21) Appl. No.: 11/097,623

(22) Filed: Apr. 1, 2005

(51) Int. Cl. H04R 3/00

(52) U.S. Cl. 381/92

(57) ABSTRACT

A system and associated methods for processing three-dimensional audio information for surround or stereo applications include a microphone assembly having three substantially coincident microphone elements. The microphone elements include one bidirectional-pattern microphone and two unidirectional microphones. The unidirectional-pattern microphones may generally face front and rear directions and align substantially with a null plane of the bidirectional element. As such, the output signals of the three microphones may be processed by a decoder into multiple channels, including, for example: left (L), center (C), right (R), surround left (SL), surround center (SC), surround right (SR), and height (H). Accordingly, the system may be used, for example, to capture sounds in three dimensions using a compact, small form-factor, single integrated microphone. One or more aspects of the invention may be capable of processing, for example, hemispheric sonic images through existing and future stereo or surround playback systems.

### TECHNICAL FIELD

This invention relates to microphones and associated systems and methods for processing three-dimensional sound image information.

### BACKGROUND

Sound recordings allow sound images that occur at one time to be replayed at a later time. The ability to record and play back sounds has revolutionized the movie industry, for example, and has made possible the music recording industry. Until recently, most sound images were recorded or played back using one channel (mono) or two channels (stereo).

In everyday life, a listener experiences sounds in three dimensions. In some environments, such as an outdoor environment, or in a large venue such as a medieval cathedral, sound may be perceived at angles that approximate a hemisphere.

To capture and play back sound images in three dimensions, more than two channels may be used. Channels may be separated based on the original direction of the components of the sound image. Using technology known as surround sound, multiple channels may be played back on speakers located around an audience to reproduce a “surround sound” image. In home and movie theatre sound systems, for example, playback of sound images using surround sound technology can enhance the overall viewing experience by adding a sense of realism—that the listener is in the middle of the action.

Certain three-dimensional sound images may be documented and preserved for future generations. For example, historians may wish to capture the three-dimensional sound images produced by a choir performing in a historic cathedral. Biologists may wish to preserve the three-dimensional sound images of rare animal species as they exist in their native environment. Such preserved sound images may be played back long after the building has been torn down, or a species has become extinct. Ideally, the sound images contain the richness of three-dimensional acoustic information that was present in the original sound image.

Technology advances have changed how sound images appear to be located. Using single-channel (mono) technology, a sound image may appear to have a single location. Using two-channel (stereo) technology, sound images may appear to have locations based on Left (L) and Right (R) channels. Using multiple-channel “surround sound” techniques, sound images may appear to have locations based on Left (L), Right (R), Center (C), Surround Left (SL), Surround Right (SR), or Surround Center (SC), and Height (H), for example.

Applications for surround sound technology are expanding, and already include, for example, home entertainment (e.g., TV programming, and home audio/video receivers), video gaming, and motion pictures. As such, there is a need for new audio equipment capable of capturing three-dimensional sound images.

### SUMMARY

A system and associated methods for processing three-dimensional audio information for surround or stereo applications include a microphone assembly having three substantially coincident microphone elements. The microphone elements include one bidirectional-pattern microphone and two unidirectional microphones. The three microphones are arranged such that the unidirectional-pattern microphones are substantially aligned with a null plane bisecting the bidirectional-pattern. As such, the output signals of the three microphones may be processed by a decoder into multiple channels, including, for example: left (L), center (C), right (R), surround left (SL), surround center (SC), surround right (SR), and height (H). Accordingly, the system may be used, for example, to capture sounds in three dimensions using a compact, small form-factor, single integrated microphone. One or more aspects of the invention may be capable of processing, for example, hemispheric sonic images through existing and future stereo or surround playback systems.

In one aspect, a decoder may process the output signals from the microphone to provide multiple channels of output signals in several different surround-sound formats, including, for example, Dolby AC-3, Dolby EX, and other 5.1, 6.1, and 7.1 multi-channel formats. In addition, the decoder may be configured to process the microphone output signals compatible with various stereo techniques, including, for example, X-Y, M/S, or Blumlein. As such, a low-cost, simple-to-use decoder may provide multiple channels in various stereo or surround-sound formats.

In some embodiments, the decoder may optionally be integrated into a compact form-factor with the three microphones to provide a low-cost, simple-to-use sound image processing system capable of directly outputting multi-channel signals in stereo or surround-sound formats. Alternatively, the decoder may be implemented remotely from the microphone. In such embodiments, pre-amplifiers may be integrated with the microphone, integrated with the decoder, or separately provided between the microphone and the decoder.

In embodiments, the decoder may be implemented in analog or digital hardware or in software, or in any combination thereof. In some examples, decoding may take place in real-time. In other examples, signals may be recorded and stored in either analog or digital format, and subsequently retrieved and decoded. In a particular embodiment, the decoder function may be implemented by processor-executed instructions, which may be incorporated into a software plug-in, for example.

In another aspect, a stand supports three microphone elements, including a bidirectional-pattern microphone and two unidirectional-pattern microphones, in a substantially coincident arrangement to form a microphone. The stand includes a base and a main support member coupled to the base. Attached to the main support member are means for holding each of the microphone elements such that the unidirectional-pattern microphones are substantially aligned with a null plane bisecting the bidirectional pattern.

In some embodiments, the microphone holding means permits the angle between the unidirectional pattern microphones to be adjustable from about 90 degrees to about 180 degrees. In various embodiments, the stand may be adjusted to orient the microphone assembly between a substantially vertical orientation and a substantially horizontal orientation.

Some embodiments may provide one or more advantages. For example, accurate recordings of three dimensional sound images may be achieved with a single, compact, low-cost microphone. A decoder with multiple-channel surround output signals may be integrated into the microphone to form a complete three-dimensional sound image processing system. Embodiments of the system may be simple to use and set-up, enabling surround or stereo format images to be processed with little or no equipment adjustment or detailed knowledge of signal processing. Optionally, microphone level signals may be amplified by a user-supplied pre-amplifier. A stand adapted to support user-supplied microphone elements, may permit flexible use of the techniques described herein.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a sound image processing system.

FIG. 2 is a sound image processing system in a single package.

FIG. 3 shows bidirectional and unidirectional polar response patterns.

FIGS. 4A-4D show top, front, side, and perspective views of exemplary microphone assemblies.

FIGS. 5A-5D shows top, front, side, and perspective views of exemplary microphone assemblies having variable angles between the unidirectional microphones.

FIG. 5E shows an implementation configured to record in stereo X-Y format.

FIG. 5F-5H show a steering mechanism for orienting the unidirectional elements.

FIG. 6 is an exemplary sound image processing decoder system.

FIG. 7 is an exemplary decoding circuit.

FIG. 8 is an exemplary flowchart of a method of operating the sound image processing decoder system of FIG. 6.

Like reference symbols in the various drawings indicate like elements.

### DETAILED DESCRIPTION OF ILLUSTRATIVE EMBODIMENTS

In general terms, apparatus and methods relating to a microphone assembly having three elements may be used to record hemispherical sound images that may be reproduced in formats such as mono, two-channel stereo, and multi-channel or surround-sound formats, such as Dolby AC-3, Dolby EX, and other 5.1, 6.1, and 7.1 multi-channel formats. Embodiments may provide channel outputs that include: Left (L), Right (R), Center (C), Surround Left (SL), Surround Right (SR), Surround Center (SC), and Height (H). These channels are derived by processing the output signals from three microphone elements arranged as described herein. During playback, certain embodiments may accurately reproduce the sound image in three dimensions, including a height channel.

Referring to the drawings, and in particular to FIG. 1, an exemplary system 100 for processing microphone output signals from a microphone assembly 105 is shown schematically. The microphone assembly 105 has three output signals 110a, 110b, 110c, which generally correspond respectively to front, bidirectional (sides), and rear directions as received by corresponding front, bidirectional, and rear microphone elements (described subsequently) of the assembly 105. In this example, the signals 110a-110c are at microphone-level until amplified by pre-amplifier 115. Pre-amplifier 115, which may be user-supplied, transmits the microphone signals at line-level to a decoder 120. The decoder 120 processes the microphone signals to provide output signals 125 in a multi-channel format.

The output 125 may provide for transmitting up to at least 7 channel output signals, the exact number of active signals depending on the selected output channel format. The outputs 125 may provide for any or all of the following channels: Left (L), Right (R), Center (C), Surround Left (SL), Surround Right (SR), Surround Center (SC), and Height (H). The decoder 120 may produce output signals in any of the following commercially available formats and techniques: Dolby AC-3, Dolby EX, and other 5.1, 6.1, and 7.1 multi-channel formats, and stereo X-Y, M/S, and Blumlein techniques. It should be appreciated that any number of other formats, both currently known and yet to be developed, may be achieved by modification of the exemplary methods and embodiments as described herein, or as may be otherwise conceived, and such other formats are within the scope of this disclosure.

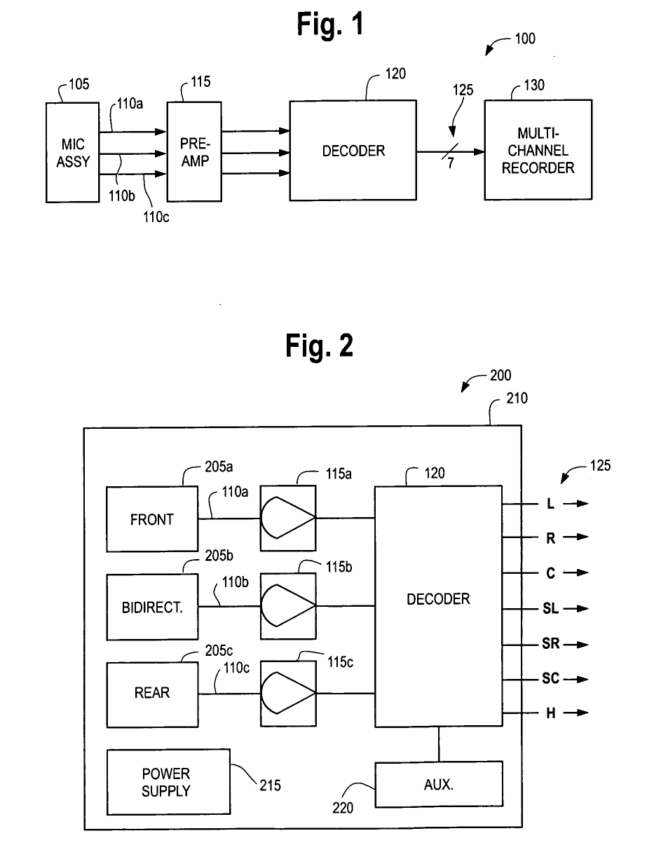

Referring now to FIG. 2, an exemplary three-dimensional sound image processing system (SIPS) 200 includes the front 205a, bidirectional 205b, and rear 205c microphone elements of the microphone assembly 105, combined with the decoder 120 in a single package 210. The package 210 may have a compact form factor and a convenient shape, such as the shape of a conventional hand-held microphone. In this example, the SIPS 200 has the outputs 125, and incorporates pre-amplifier gain stages 115a, 115b, and 115c for each microphone output 110a, 110b, and 110c, respectively.

In this example, the SIPS 200 also includes a power supply 215 that may provide operating current and voltage. In wireless applications, for example, power may be received from a battery associated with the power supply 215. In wired applications, the SIPS 200 may draw operating power from an external energy source.

The outputs 125 may transmit line-level decoded signals over a cable connected to the SIPS 200. Alternatively, a wireless transmitter may send two or more channels of decoded information using, for example, radio frequency (RF) techniques. In various embodiments, the transmission may be modulated (AM or FM) in response to the decoded signals, or the decoded signals may be converted to digital values by an analog-to-digital conversion (ADC) process in an auxiliary circuitry 220. The digital values may be transmitted, either by wired or wireless methods, using known digital communication techniques. The auxiliary circuit 220 may include user inputs (e.g., buttons, switches), visual indicators (LEDs, LCDs, audio feedback) or other means for programming or operating the SIPS 200.

In one embodiment, the SIPS 200 of FIG. 2 may be integrated as a sub-system in another device (not shown), such as an audio/video recorder. In such an embodiment, the audio/video recorder may include the SIPS 200 in a housing with the video sub-system. In an alternative embodiment, the SIPS 200 may be configured as an accessory that may be connected to the audio/video recorder as an optional accessory. When connected, the video subsystem may advantageously cooperate with the attached SIPS 200 to capture three-dimensional sound images. The sound image information may be stored, for example, in a data storage device on-board the audio-video recorder, an external data storage device in communication with the audio-video recorder, or on data storage device in the SIPS 200.

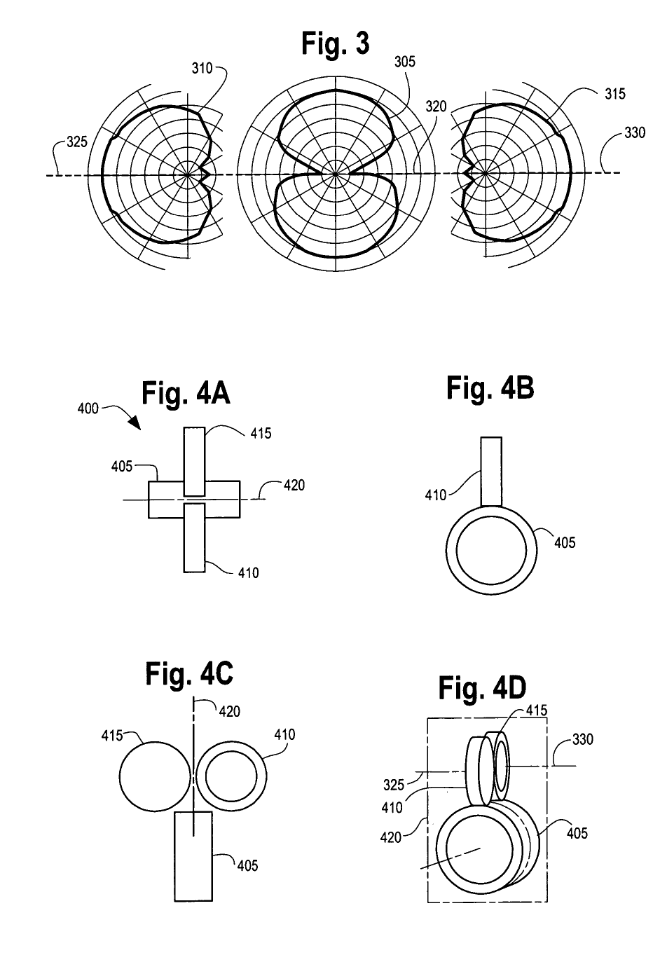

Two types of exemplary polar response patterns are illustrated in FIG. 3. Polar response patterns may be used to represent the response of a microphone to sound sources from various directions. First, a bidirectional response pattern 305 represents a typical response of a bidirectional microphone element. Second, unidirectional patterns 310 and 315 represent typical response patterns for front- and rear-facing unidirectional microphone elements.

For three microphone elements, in various embodiments, the polar response patterns 305, 310, 315 would substantially overlap. To aid understanding, the response patterns 305-315 are illustrated as being separated out to clearly show each individual pattern.

The bidirectional response pattern 305 is substantially symmetric about a null plane 320, and thus is approximately equally responsive on the two opposing faces of the microphone. Along the sides, where the null plane 320 is defined, the bidirectional pattern 305 exhibits a substantially negligible response.

The unidirectional capsules may have, for example, a substantially cardioid, supercardioid, or hypercardioid response pattern. The cardioid response patterns 310, 315 of this example represent a substantially unidirectional microphone response, in that they respond primarily to sound incident from the direction that the microphone is facing. The exemplary cardioid polar responses 310, 315 may be said to define axes 325, 330, respectively. Such axes are typically approximately perpendicular to the planar surface of the corresponding microphone's diaphragm.

A microphone and associated methods, computer program products, and systems may relate to an arrangement of three microphones. An exemplary assembly 400 of three microphone elements is shown in FIGS. 4A, 4B, 4C. A modified embodiment is shown in FIG. 4D. Referring to FIGS. 4A-4C, the assembly 400 includes one bidirectional microphone element 405 and two unidirectional microphones 410, 415. The microphones 405, 410, 415 may be arranged to be substantially coincident such that phase displacement of sound image information among the capsules is negligible. In this example, the bidirectional capsule 405 is below two unidirectional capsules 410, 415. The two unidirectional capsules 410, 415 may be oriented so that one capsule is pointed forward (i.e., front (F)) and substantially in the null plane 420 of the bidirectional capsule 405, and the other unidirectional capsule is pointed rearward and substantially in the null plane 420 of the bidirectional capsule 405. The unidirectional capsules 410, 415 may have a response pattern that is, for example, substantially cardioid-shaped.

In some embodiments, the microphone assembly may use conventional, commercially available microphones as described for each of the three elements 405, 410, 415. The bidirectional microphone 405 may be of any suitable type having a substantially bidirectional response pattern, such as a ribbon microphone. A ribbon microphone is a form of dynamic microphone, with a thin metallic ribbon (which serves as both voice coil and diaphragm) suspended between the poles of a magnetic circuit.

Various embodiments of the microphone assembly 400 may be advantageously used to capture sound images that include a height (H) channel component. For example, as the angle of incidence of a sound source approaches congruence to both unidirectional capsules, off-axis coloration and polar pattern differences between capsules may decrease, allowing a greater additive component to the two signals. Since these capsules are mounted above the bidirectional one, the movement of sound sources overhead from front to rear achieves a congruent angle of incidence to the two unidirectional capsules at the apex above the capsules. This may yield an increase in amplitude when sound is at the apex.

Although one exemplary arrangement has been illustrated as microphone assembly 400, a modified arrangement is shown as exemplary microphone assembly 450 in FIG. 4D. For example, the microphones 410, 415 may have a cylindrical shape of sufficient length that an end-to-end (i.e., coaxial) arrangement may result in the corresponding elements being separated by a significant distance. A significant distance may impact overall form factor, or add phase displacement among the microphone elements. As shown, the elements 410, 415 are offset to opposite sides of the null plane 420 of the bidirectional microphone 405. In this way, substantial coincidence or near coincidence of the microphone elements 405, 410, 415 may be preserved, while providing the features and performance advantages described herein. In alternative embodiments, the microphone elements 405, 410, 415 may have modified positions, such as to accommodate various form factors and packaging considerations, but maintaining substantial or near coincident relationship and relative orientation, as described generally herein. In one alternative example, the elements 410, 415 may be stacked on top of one another on top of the element 405.

In various embodiments, the microphone elements 405, 410, 415 may be arranged in orientations in which the unidirectional elements 410, 415 are substantially aligned along the null plane 420. Such arrangements may provide a polar response pattern corresponding to those described with reference to FIG. 3.

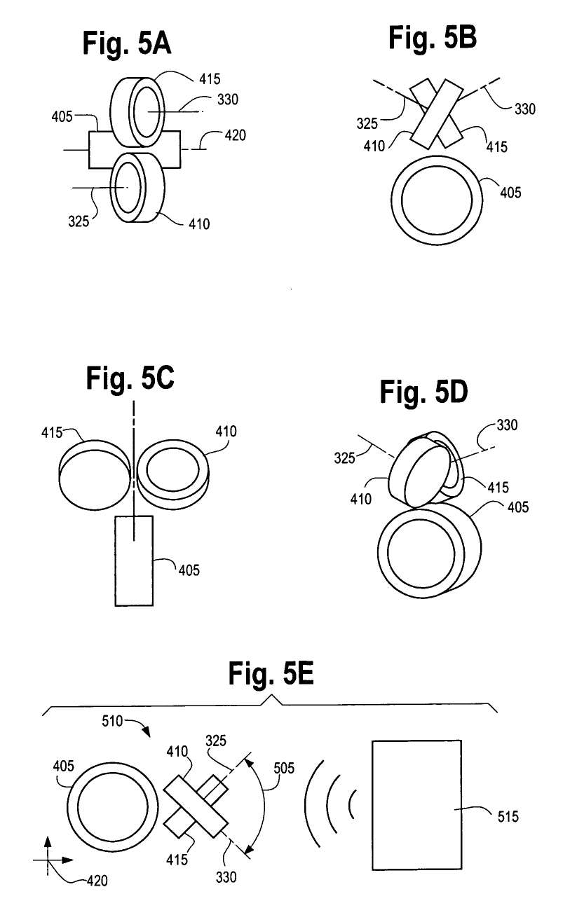

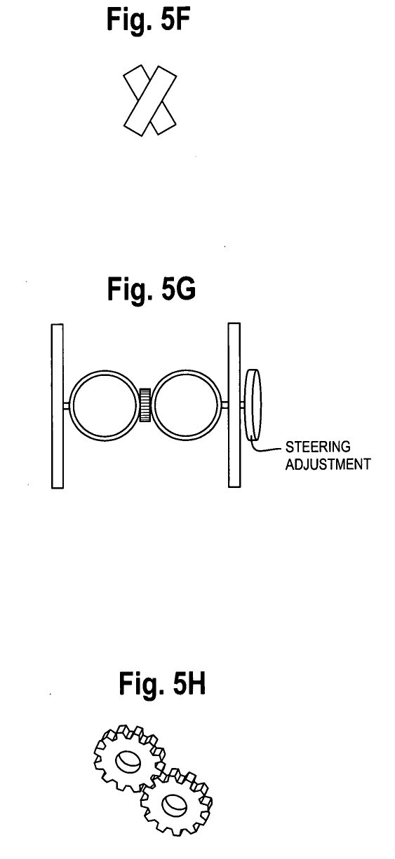

In the examples of FIG. 4, the axes 325, 330 of the unidirectional microphones 410, 415 are oriented substantially along the null plane 420 of the bidirectional microphone 405, and their axes 325, 330 are substantially parallel. With reference to FIGS. 5A, 5B, 5C, and 5D, the axes 325, 330 are oriented such that they are not substantially parallel. For example, the axes 325, 330 may have projections onto the null plane 420 that intersect at angles that may include any angle, and preferably from about 90 degrees to about 180 degrees. In particular embodiments, by way of example, the axes may be substantially parallel (i.e., 180 degrees), substantially orthogonal (i.e., 90 degrees), 135 degrees, or at increments of about 5 degrees or about 10 degrees between about 90 and about 180 degrees. In some embodiments, the angle between the axes of the unidirectional capsules may be articulated to provide a range of angles from about 90 degrees to about 180 degrees.

As an example, with reference to FIG. 5E, a microphone assembly 510 may be used to record in stereo X-Y format by suitably orienting the assembly 510 and setting the angle 505 anywhere from about 90 degrees to about 180 degrees. The microphone may be oriented so that sound source of interest generally lie between the axes 325, 330, and the microphone elements 410, 415 are generally directed toward a particular sound source 515 of interest. For example, the microphone assembly 510 may be configured so that the angle 505 between the axes 325, 330 includes a planar region that is generally directed toward the sound source 515.

In FIGS. 5F, 5G, and 5H, an exemplary steering mechanism is shown. The steering mechanism may be used to articulate the unidirectional elements to have substantially symmetric orientations with respect to the null plane. The steering mechanism may be used, for example, to orient the microphone elements into the various angles described with reference to FIGS. 5A-5E.

As was shown in FIGS. 1 and 2, the decoder 120 may be located remotely from the microphone assembly 105, or integrated with the microphone assembly 105 into the same housing 210. In either case, the decoder 120 may cooperate with sub-systems that provide additional functionality and flexibility to a sound image processing system.

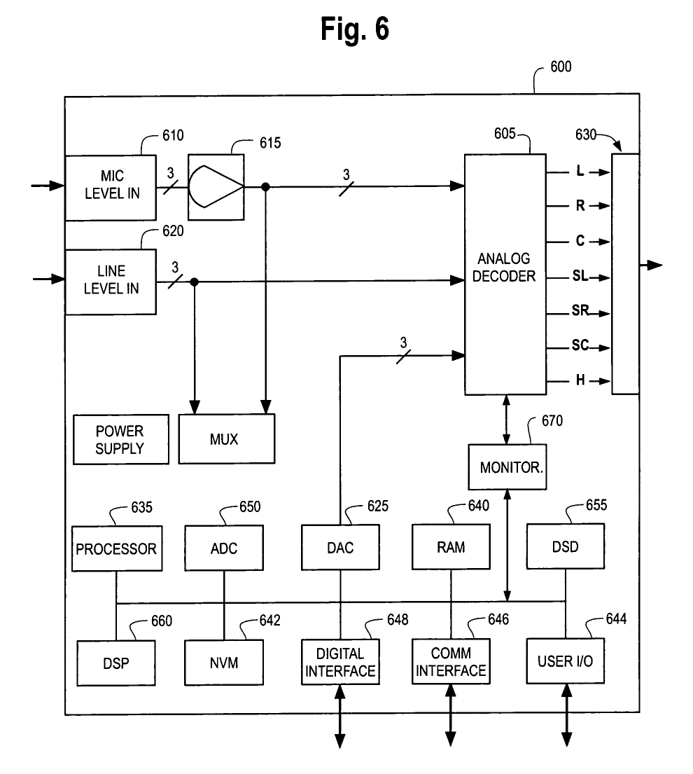

FIG. 6 shows an exemplary sound image processing decoder system 600. The system 600 includes an analog decoder 605. The analog decoder 605 is coupled to a pre-amplifier 615 that can receive the three microphone signals corresponding to signals 110a-110c from a microphone-level input 610. The analog decoder 605 is also coupled to receive line-level input signals directly from a line-level input 620. In this example, the decoder 605 is also coupled to a digital-to-analog converter (DAC) 625. The analog decoder 605 can process signals from any of these sources as they are received, and convert the signals into decoded output signals in a selected multi-channel format. In this example, the analog decoder 605 can output the following channels: Left (L), Right (R) Center (C), Surround Left (SL), Surround Right (SR), or Surround Center (SC), and Height (H). These signals may be transmitted through an output port 630, which may have associated drive circuitry for driving the signals through a cable, for example, to a recording device or other apparatus for receiving, storing, or otherwise processing signals in output channel format.

The system 600 further includes a processor 635 to provide advanced functionality, including general status monitoring, user interface functions, self-diagnostic testing, self-calibration, and supervising operations, such as communications and operating mode, data processing, error detection and correction, or other associated status, control, operating, supervisory, or housekeeping tasks.

In this example, the processor 635 is coupled via a bus to a RAM 640 to provide volatile memory for fast access or buffering, a non-volatile memory (NVM) 642 that retains data when power is removed, a user input/output (I/O) interface 644 that receives input commands and provides status information to an operator, a communication interface 646 to provide interconnectivity to a packet-based data communication network (e.g., LAN, WAN, intranet, VPN, SONET/SDH), and a digital interface 648 for sending and receiving digitally encoded information (e.g., USB, Ethernet, Firewire, SATA) between two or more devices.

The processor 635 is also coupled via the bus to an ADC 650. The ADC 650 allows the three received analog microphone signals being received by the analog decoder 605 to be sampled and stored. In this example, the ADC 650 is also configured to sample any or all of the channel output signals received by the port 630. This feature permits the decoding operation to be performed and the result stored in digital format. As such, sound image signal processing is possible within the limits of available data storage capacity in the system 600. Moreover, the sampled information may be used for other purposes, such as calibration (e.g., off-set and gain adjustment), self-tuning, error detection and correction, and noise reduction. Some of these, or similar techniques, may be performed in cooperation with a device that is configured to receive the channel output signal via the port 630.

Data that may be stored in memory, such as NVM 646 or a data storage device DSD 655, may include various operational and configuration information. Such information may relate to, for example, user settings, gains, switch settings, filter responses, levels, formats, or other parameters about the decoding process or the user interface. Sets of information about particular applications or preferences may be stored, downloaded, exported, or recalled. In some embodiments, such information may be communicated between by the processor 635 over the bus to the analog decoder 605 via a monitor interface 670. The monitor interface 670, in this example, permits bidirectional communication of status and control signals for configuring and monitoring the analog decoder 605.

Large blocks of digital data, either containing input data to be decoded, or containing output data that has already been decoded, may require a large data storage capacity. To provide a large data storage capacity, the system 600 includes a data storage device (DSD) 655, also coupled to the processor via the bus. The data storage device 655 may include a hard disk drive, tape drive, solid-state memory, or other type of high-capacity memory device. Increasing the memory capacity may enable any or all of: (1) higher sampling rates, which are associated with audio quality, (2) longer recording time periods, and (3) increased numbers of output channels. On-board, high capacity data storage may increase the portability and utility of the system 600, thereby expanding the available applications that can make use of the system 600.

In applications for which data storage capacity may be a limiting factor, data storage capacity utilization may be maximized, for example, by sampling and storing the three original microphone signals, rather than decoding and storing 4 or more channels of decoded output signals. Some parameters relating to decimation, ADC-related errors, data compression, and signal processing throughput rate, for example, may influence the optimal use of data storage capacity. At an appropriate time, such as when a multi-track recording device is coupled to receive channel output signals via the port 630, the processor may cause the stored input data to be digitally decoded, or converted back to analog via the DAC 625 and processed through the analog decoder 605.

Similarly, digitally formatted microphone input signals may be downloaded via the communication interface 646 or the digital interface 648 into memory locations in the system 600. The data may be digitally decoded and output in digital format. Alternatively, such data may be converted to three channels of analog signals via DAC 625 and then processed through the analog decoder 605 into a selected output channel format (e.g., X-Y, M/S, Blumlein, Dolby AC-3, Dolby EX, 5.1, 6.1, or 7.1). The decoded output channel signals may be sent out in analog format via the port 630 to a recording device, or converted back to digital format and stored in memory locations in the system 600, or transmitted out via the communication interface 646 or the digital interface 648. Appropriate user input controls may be provided for the user to monitor or direct the flow of data in the system 600.

The digital interface 648 may provide for exchanging data with other local processor-based devices. The interface may be compatible with protocols that may employ wired (e.g., USB, Firewire, Ethernet), infrared, optical fiber, or low-power RF (e.g., Bluetooth) communication links with electronic equipment, such as a mixer or a multi-track recorder. For example, the decoder may automatically download the contents of certain on-board memory whenever a USB 2.0-compliant data storage device, such as a memory stick, thumb drive, or hard disc drive, is connected to the digital interface 648. The digital interface 648 may provide for communication with professional grade audio equipment, such as a mixer system, using commercially available protocols, including AES/EBU, fiber optic (ADAT), S/MUX, TDIF, Firewire, and SPDIF. As such, the digital interface 648 may include one or more ports for data transmission, including use of one or more optical fibers.

The user interface 644 is operatively coupled to allow a user to monitor, control, adjust, or otherwise interface with the system 600. The user interface 644 may include, for example, five variable gain inputs (described subsequently), or their equivalents, for setting gains in the analog decoder 605. In addition, a selection switch (described subsequently) may be provided to select the output format. These and other inputs may be implemented using alternative input devices, such as a keypad coupled to the user I/O interface 644, or a laptop or handheld computer coupled to the digital interface 648, for example.

In alternative embodiments, the decoding function may be implemented in analog hardware, digital hardware, in a programmed processor executing instructions, or in any combination thereof. Accordingly, where the three microphone signals described herein are sampled and converted to digital format, the decoding function described herein may be performed digitally by executing instructions as an alternative to processing in the analog decoder 605.

In various implementations, such as those that may involve collection of sound image information in remote locations, the system 600 may optionally provide a communication interface 646 coupled to a transceiver or transmitter to transmit channel information for remote storage, decoding, recording, or processing. The communication interface 646 may be bidirectional, and configured to receive operational commands that are routed to the processor for processing. Communication methods may include, for example, radio frequency (e.g., AM, FM, FSK), cellular telephone, satellite, optical fiber, infrared, or other wireless communication method. In wired embodiments, the decoder may transmit information, for example, via a modem, LAN, WAN, or via a packet-based network connection, such as an intranet, VPN, or the Internet.

In one embodiment, the processor 635 may perform the decoding function, either in parallel with, or instead of, the analog decoder. In some embodiments, the computational burden on the processor 635 of processing the incoming samples of three microphone outputs may impose practical limits on, for example, the sample rate or number of output format channels that may be processed in real-time. In such cases, some of the computational workload may be off-loaded to another processor. In this example, the processor 635 is also coupled via a bus to a math-coprocessor, or alternatively a digital signal processor (DSP) 660. The DSP 660 may execute instructions to implement the decoding function. The DSP 660 may provide a high-speed computational capability that can reduce the computational burden on the processor 635. In embodiments with the capability to process all the necessary computations quickly enough to support the desired sampling rate and selected output channel formats, the sound images captured by the microphone assembly 105 may be continuously recorded in a selected output channel format in real-time.

In addition to decoding, the system 600 may provide other signal processing capability. For example, each input channel may be processed through filters using digital or analog hardware, or using instructions executed on a processor. For example, one or more processors may digitally filter (e.g., FIR or IIR) one or more of the output channels using known digital signal processing techniques. As another example, an analog filter may tailor the frequency response of the bidirectional microphone output signal. Other examples of filters may be used.

In various examples, the system 600 may further include software for execution on a processor that provides processing capability for future output channel formats. If, for example, one or more additional output channels are developed, the analog decoder may not be readily adapted to support the added channels. The software executed by the processor 635 and the DSP 660, for example, may be updated via the digital interface 648, for example, to process the additional information. The channel information may be captured in analog format via unused analog inputs, for example, and selectively monitored using multiplexers to couple the additional signals to the ADC 650. Alternatively, the additional channel information may be received into the system through the digital interface 648, for example, and processed by the processor 635 and/or the DSP 660. The decoded output information in digital format may be processed as described elsewhere herein.

The recording device, which may be connected to the port 630, may be a multi-channel recorder or a mixer system, for example. The recording device may also include an analog-to-digital conversion stage coupled to a memory or other data storage device for storing the decoded channel information to a data storage medium, such as a hard disk drive of a laptop computer, for example.

In this example, the system 600 includes both line-level and microphone-level inputs 610, 620 to allow for users to provide their own pre-amplification devices. Some users may prefer to supply a particular pre-amplification stage to amplify microphone levels signals for subsequent transmission to the line level input of the decoder. In another embodiment that may receive both microphone- and line-level inputs, the system 600 may provide a single combination input port that is controlled by a manual selectable level switch, or by an auto-detecting level circuit, to automatically detect the input signal levels received by the port.

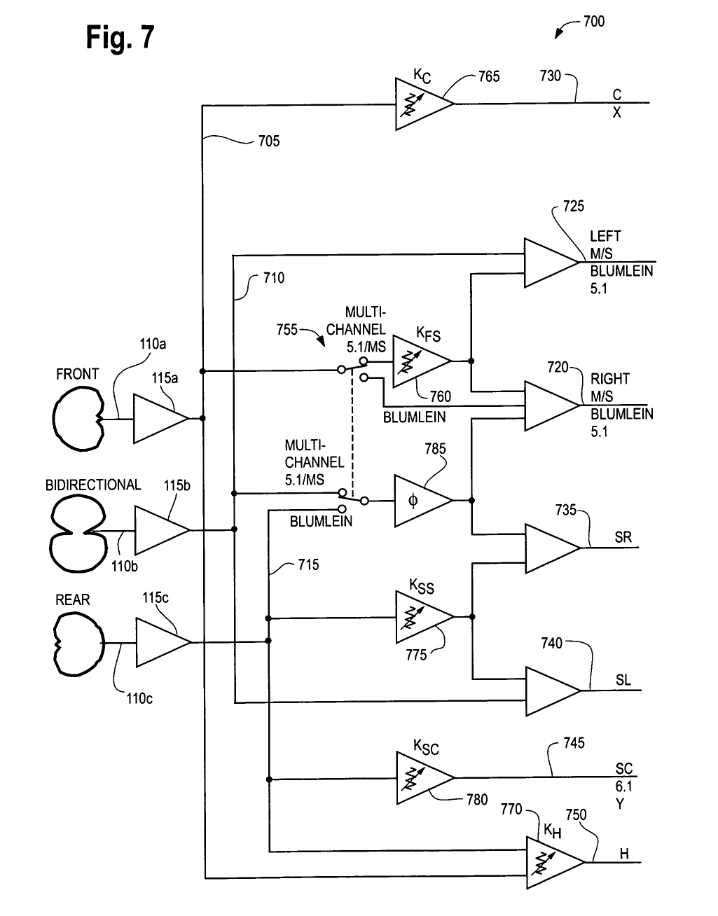

The decoder 605 may process output signals from the microphone assembly 105 according to predetermined relationships. One implementation of these predetermined relationships is shown by an exemplary decoding circuit 700 in FIG. 7.

The decoding circuit 700 has as input nodes a front input node 705, a bidirectional input node 710, and a rear input node 715, which correspond, respectively, to pre-amplified versions of nodes 110a, 110b, and 110c. The decoding circuit 700 also has as outputs nodes 725, 730, 735, 740, 745, 750, which correspond to the following channels: R, L, C, RS, LS, CS, and H. These output channels may be compatible with the following output formats or techniques: Dolby AC-3, Dolby EX, and other 5.1, 6.1, and 7.1 multi-channel formats (including Height channel), or stereo X-Y, M/S, and Blumlein.

The decoding circuit 700 has two modes of operation based on the position of switch 755, which is a double-pole, single-throw switch or relay. In a first position (as shown in FIG. 7), the decoding circuit 700 may support any of the following output formats: Dolby AC-3, Dolby EX, and other 5.1, 6.1, and 7.1 multi-channel formats, as well as stereo X-Y and M/S. In a second position, the decoding circuit 700 may support the Blumlein output format.

In this example, each of the output channels is based on a predetermined function that comprises a linear combination of the three input nodes 705, 710, 715. The linear combination may be expressed mathematically as a linear system of equations.

An exemplary linear equation for Dolby 6.1 (with Height channel) is as follows:

Kfs is a front stereo angle gain factor associated with amplifier 760. It may have a user-selectable value in a range, for example, from about −3 dB to about +6 dB.

Kc is a center channel gain factor associated with amplifier 765. It may have a user-selectable value in a range, for example, from infinite cut to about +3 dB gain.

Kh is a height gain factor associated with amplifier 770. It may have a user-selectable value in a range, for example, from infinite cut to about +3 dB gain.

Kss is a surround stereo angle gain factor associated with amplifier 775. It may have a user-selectable value in a range, for example, from about −3 dB to about +6 dB.

Ksc is a surround center gain factor associated with amplifier 780. It may have a user-selectable value in a range, for example, from infinite cut to about +3 dB gain.

$$[ \begin{matrix}R \\ L \\ C \\ RS \\ LS \\ CS \\ H\end{matrix} ] = [ \begin{matrix}Kfs & - 1 & 0 \\ Kfs & 1 & 0 \\ Kc & 0 & 0 \\ 0 & - 1 & Kss \\ 0 & 1 & Kss \\ 0 & 0 & Ksc \\ Kh & 0 & Kh\end{matrix} ] \cdot [ \begin{matrix}Front \\ Bipolar \\ Rear\end{matrix} ]$$

An exemplary linear equation for Blumlein is as follows:

$$[ \begin{matrix}R \\ L\end{matrix} ] = [ \begin{matrix}1 & 0 & - 1 \\ 0 & 1 & 0\end{matrix} ] \cdot [ \begin{matrix}Front \\ Bipolar \\ Rear\end{matrix} ]$$

In the first mode of operation, corresponding to the switch 755 being in the first position, the decoding circuit 700 processes the microphone output signals as follows:
The Right channel node 720 is the difference of the Front node 705 attenuated by Kfs and the bidirectional node 710;
The Left channel node 725 is the sum of the Front node 705 attenuated by Kfs and the Bidirectional node 710;
The Center channel node 730 is Front node 705 attenuated by Kc, with consideration of mixing a portion of the true center image in with phantom center);
The Surround Right channel node 735 is the difference of the Rear node 715 attenuated by Kss and the Bidirectional node 710;
The Surround Left channel node 740 is the sum of the Rear node 715 attenuated by Kss and the Bidirectional node 710,
The Surround Center channel node 745 is the Rear node 715 attenuated by Ksc.
The Height channel node 750 is the sum of the Front node 705 and the Rear node 715, the sum being attenuated by Kh.

Microphone design provides for stereo M/S is available in any multi-channel mode, unless the switch 755 is in the Blumlein position.

X/Y outputs are available at the Center channel node 730 and Surround Center channel node 745, interchangeably. For example, the X output may be taken from the node 730, and the Y output may be taken from the node 745. Unless the switch 755 is in set for Blumlein mode operation, X/Y outputs are available from the 2 unidirectional microphone elements 410, 415 when oriented horizontally, as shown in FIG. 5E.

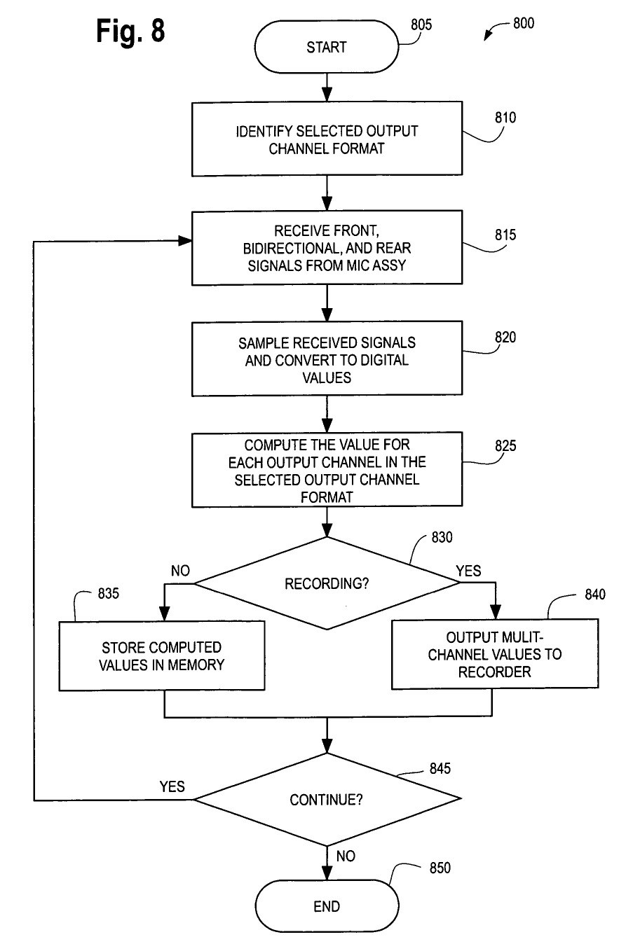

Steps of a method that may be performed by various embodiments are shown in an exemplary flowchart 800 in FIG. 8. In this example, the method may be performed by a processor executing instructions. For example, the method may be performed by the processor 635 or the DSP 660, or in combination, in the system 600 of FIG. 6.

Starting at step 805, the method may begin, for example, in response to a signal to process incoming microphone signals from the microphone assembly 105 into a selected multi-channel format. At step 810, a selected output channel format is identified, such as by receiving a user-input or command via, for example, the user interface 644. Next, the front, bidirectional, and rear signals from the microphone assembly 105 may be received at step 815. Then, at step 820, the received signals are sampled and converted to digital values. The sampled values are next used to compute the corresponding value for each of the output channels at step 825.

If, at step 830, the output values are not being recorded at that time, which may be in real time, then the computed values are stored in memory at step 835. However, if the output values are being recorded at that time, then the multi-channel output values are output to a recorder at step 840.

Next, a check is made at step 845 to determine whether to continue. This determination may be made on available memory capacity, the presence of a stop signal command, or the cessation of signals from the microphone assembly. If it is determined that processing is to continue, the step 815 is repeated. Otherwise, the method terminates at step 850.

In addition to the above-described examples, sound image processing systems may be implemented using systems, methods, or computer program products in embodiments other than the examples described above.

For example, a computer program product contains instructions that, when executed by a processor, perform operations corresponding to variations of the method in the flowchart of FIG. 8. For example, in one modification of the method, the computer program product may process sampled values of the microphone input signal that had been previously converted to digital format, and thereby do not require performing step 820. In offline applications in which real-time recording is not involved, the step 830 may be modified to check for a signal other than a recording signal to determine whether to store the values in a memory device or to output them to a recording device.

Each of the microphone output signals, after amplification, may be sampled at a sample rate sufficient to reproduce a high-fidelity audio output signal after processing. For example, the sample rate in some embodiments may be any frequency above 20 kHz, such as between about 64 kHz and 96 kHz, or particular standard frequencies, such as 44.1 kHz, 48 kHz, 88.2 kHz, 96 kHz, 192 kHz, or other higher or lower frequencies, such as may be used with direct streaming digital recording. The sampled values may be converted by one or more A-to-D converters, and stored in a memory location, such as a register, a memory buffer, or an address in another non-volatile data storage device.

In some embodiments, the computer program product may process sampled values of the microphone output signals in real-time, with only a slight processing delay that may be, in some implementations, imperceptible to a human observer. For example, real-time computations may be performed using well-known methods, such as finite impulse response (FIR), infinite impulse response (IIR), parallel-processing, multi-threaded processing, or other similar processing methods. Such computations may be implemented, for example, in a microprocessor, math-coprocessor, digital signal processor, microcontroller, or similar components.

In other embodiments, the computer program product may process sampled values of the microphone output signals off-line (i.e., not in real-time). This may be done, for example, due to limits on the computational workload of the processing system, to reduce bandwidth requirements for the processing system, or to reduce power consumption while the sound image is being captured. In some embodiments, the processing system may allocate, for example, processing tasks on a limited “as available” basis. In such an embodiment, the processor may apply resources to decode stored sampled values whenever sufficient computational bandwidth is available. Computational bandwidth availability may decrease, for example, when receiving microphone input signals.

The instructions of the computer program product may be associated with a “plug-in” for a pre-existing software package. Alternatively, the instructions may be executed as a stand-alone program that converts stored samples of three-channel, digitized audio into a desired output format (e.g., Blumlein, Dolby EX, or 5.1).

Associated with the computer program product may be a user interface (UI) for selecting parameters of operation for the decoding process. In certain implementations, the UI may be a graphical user interface (GUI) to simplify the interface for the user by permitting, for example, user input to be made with a computer pointing device, such as a mouse. Through the UI, the user may supply parameters relating to minimum and maximum file sizes, minimum or maximum over-sampling factors, data compression (e.g., decimation), alternative file formats (e.g., .wav), and channel formats, for example. Channel formats may be defined according to the best available sound playback system. If a playback system is configured to playback Dolby EX, for example, then the additional channel (H) need not be processed. In this way, computational savings and memory space reductions may by achieved by not processing information for channels that are not available in a particular implementation.

The UI may also provide for user-maintenance, definition, or review of metadata associated with the channel information. For example, embodiments of the computer program product may establish database tables for storing information about individual channels. The stored metadata may include time-stamp information, user-defined reference information (e.g., descriptive labeling), channel format (e.g., X-Y, Blumlein, Dolby EX, or 5.1) gain settings (e.g., surround spread attenuation, front spread attenuation), track synchronization information, index information, and error detection and correction information (e.g., checksums). These and other metadata may be advantageously stored in one or more database tables to promote efficient and effective use of the channel information.

The sound image processing system may be implemented as a computer system that can be used with embodiments of the invention. A processor may be capable of processing instructions for execution within the system. In one embodiment, the processor is a single-threaded processor. In another embodiment, the processor is a multi-threaded processor. The processor is capable of processing instructions stored in the memory or on a storage device.

The memory stores information within the system. In various embodiments, the memory may be contained in a computer-readable medium, a volatile memory, or a non-volatile memory. The system may also include a storage device capable of providing mass storage for the system. In various embodiments, the storage device may be a computer-readable medium, a floppy disk device, a hard disk device, an optical disk device, or a tape device.

To provide for interaction with a user, the invention can be implemented on a computer having a display device such as a CRT (cathode ray tube) or LCD (liquid crystal display) monitor for displaying information to the user. The computer may also have a keyboard and a pointing device such as a mouse or a trackball by which the user can provide input to the computer. The display may be an input/output (I/O) device that provides input/output operations for the system. In embodiments, an input/output device may include a keyboard and/or pointing device, or a display unit for displaying graphical user interfaces. In some embodiments, input devices may include buttons, switches, dials, or potentiometers, and output devices may include visual indicators, such as LEDs, meters, or audible indicators, such as a speaker or buzzer, for example.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet. Communication between devices may include analog or digital modulation techniques, and may be implemented over one or more physical transport layers, or protocols, and may use any suitable communication protocol over wired or wireless (e.g., RF, infrared, optical) connections, such as MIDI, universal serial bus USB, Ethernet, Bluetooth, CAN, ATA, IDE, for example.

A number of embodiments of the invention have been described. Nevertheless, it will be understood that various modifications may be made without departing from the spirit and scope of the invention. For example, advantageous results may be achieved if the steps of the disclosed techniques were performed in a modified sequence, if components in the disclosed systems were combined in a different manner, or if the described components were replaced or supplemented by other components. The functions and processes (including algorithms) may be performed in hardware, software, or a combination thereof. The disclosed systems or certain sub-components may be integrated, in whole or in part, on a single integrated circuit (IC), or implemented using discrete components and one or more ICs. Accordingly, other embodiments are within the scope of the following claims.

1. A microphone system, comprising:
a first microphone element having a first unidirectional pattern defining a first axis;
a second microphone element having a second unidirectional pattern defining a second axis; and
a third microphone element having a bidirectional pattern defining a null plane about which opposing lobes of the bidirectional pattern have substantial symmetry,
wherein the first and second axes lie substantially along the null plane of the bidirectional pattern, and the first, second and third microphone elements are substantially coincident.

2. The system of claim 1, wherein the first and second unidirectional patterns each comprise a substantially cardioid pattern.

3. The system of claim 1, wherein the third microphone comprises a ribbon microphone.

4. The system of claim 1, wherein the first and second axes form an angle between about 180 degrees and about 90 degrees.

5. The system of claim 1, wherein the first and second axes form an angle of about 90 degrees.

6. The system of claim 1, wherein the first and second axes form an angle of about 135 degrees.

7. The system of claim 1, wherein the first and second axes are substantially parallel.

8. A system to process sound images, the system comprising:
a microphone assembly comprising:
a first microphone element having a first output and a first unidirectional pattern defining a first axis;
a second microphone element having a second output and a second unidirectional pattern defining a second axis; and
a third microphone element having a third output and a bidirectional pattern defining a null plane about which opposing lobes of the bidirectional pattern have substantial symmetry, wherein the first and second axes lie substantially along the null plane of the bidirectional pattern, and the first, second and third microphone elements are substantially coincident; and
means for decoding signals provided from the first, second and third microphone element outputs into a plurality of channel signals.

9. The system of claim 8, wherein the first and second unidirectional patterns each comprise a substantially cardioid pattern.

10. The system of claim 8, wherein the decoding means comprises an analog circuit to process the microphone element outputs into the plurality of channel signals.

11. The system of claim 8, wherein the decoding means comprises a processor that executes instructions to process the signals from the microphone element outputs into the plurality of channel signals.

12. The system of claim 8, wherein some of the plurality of channel signals are in a stereo format.

13. The system of claim 8, wherein each of the plurality of channel signals is in a surround sound format.

14. The system of claim 8, further comprising means for pre-amplifying the signals provided from the first, second and third microphone element outputs.

15. The system of claim 8, wherein the microphone assembly and the processing means are contained in separate and independent housings.

16. The system of claim 8, further comprising a housing assembly containing the microphone assembly and the processing means.

17. A computer program product (CPP) containing instructions that, when executed by a processor, cause the processor to perform operations to process a set of three microphone output signals into a plurality of channels of sound image information, the operations comprising:
receive a set of microphone signals from a microphone assembly that comprises:
a first microphone element having a first output and a first unidirectional pattern defining a first axis;
a second microphone element having a second output and a second unidirectional pattern defining a second axis; and
a third microphone element having a third output and a bidirectional pattern defining a null plane about which opposing lobes of the bidirectional pattern have substantial symmetry, wherein the first and second axes lie substantially along the null plane of the bidirectional pattern, and the first, second and third microphone elements are substantially coincident; and
process signals provided from the first, second and third microphone element outputs into a plurality of channel signals.

18. The CPP of claim 17, wherein the first and second unidirectional patterns each comprise a substantially cardioid pattern.

19. The CPP of claim 17, wherein some of the plurality of channel signals are in a stereo format.

20. The CPP of claim 17, wherein each of the plurality of channel signals is in a surround sound format.
